(19) United States
(12) Patent Application Publication
(10) Pub. No.: US 2004/0092673 A1
(43) Pub. Date: May 13, 2004

(54) Vinylester carbamide

(76) Inventors: Martin Vogel, Glottertal (DE); Juergen Gruen, Boetzingen (DE); Joachim Schaetzle, Kenzingen (DE); Christian Weber, Emmendingen (DE); Clemens Schmidt, Denzingen (DE)

Correspondence Address: Striker Striker & Stenby, 103 East Neck Road, Huntington, NY, 11743, US

(21) Appl. No.: 10/472,639

(22) PCT Filed: Mar. 5, 2002
(86) PCT No.: PCT/EP02/02384

(30) Foreign Application Priority Data
Mar. 29, 2001 (DE) 10115587.5

(51) Int. Cl. C08G 18/32

(52) U.S. Cl. 525/452

(57) ABSTRACT

The invention relates to new resins characterised by a content of curable urea derivatives; to new synthetic mortars obtainable using them; to kits for producing the synthetic mortars; to the use of the resins or synthetic mortars in fastening technology; and also to new methods of fastening which comprise the use of those resins or synthetic mortars.

### SUMMARY OF THE INVENTION

The invention relates to new resins characterised by a content of curable urea derivatives; to new synthetic mortars obtainable using them; to kits for producing the synthetic mortars; to the use of the resins or synthetic mortars in fastening technology; and to new methods of fastening which comprise the use of those resins or synthetic mortars.

### BACKGROUND TO THE INVENTION

Mortar compounds are known for the fastening of anchoring means in solid receiving materials, being characterised by a content of free-radically curable vinyl ester urethane resins (EP 0 432 087). The vinyl ester urethane resins serve to improve the strength properties of the resulting mortar compounds. Improved adhesion properties would be desirable, especially when the substrates used are damp or wet, and also better full-curing properties at relatively low temperatures and/or improved post-curing. U.S. Pat. No. 4,223,099 mentions moulding compositions which comprise a terminally unsaturated polyurethane, a vinyl or vinylidene compound which can be copolymerised with the polyurethane and 3-25% of a rubbery-elastic polymer having a glass transition temperature of between −90 and 10° C. Only urethane compounds are mentioned as examples and described in detail. The plastics are, because of their desired properties (especially resilience), not suitable for producing mortars. Against that background, the problem of the present invention is to make accessible new resins, as the basis for synthetic mortar compounds, which do not have the mentioned disadvantages and, in addition, have further advantageous properties.

### GENERAL DESCRIPTION OF THE INVENTION

It has now been found, surprisingly, that new resins comprising urea-derivative-based constituents, which are obtainable by the reactions mentioned hereinbelow, wherein further reactants or additives may be used in each case, are suitable for producing synthetic mortars (composite mortars) having very advantageous properties.

In particular, the synthetic mortars have very good adhesion properties even when the substrate is damp or wet, increased polarity and improved low-temperature curing compared to urethane compounds and also a very high degree of stability with respect to alkalis and chemicals. In addition, they exhibit very good post-curing and can be flexibly adapted to specific requirements, for example by using polar or non-polar starting materials, which adhere better to polar or non-polar substrates, respectively.

### DETAILED DESCRIPTION OF THE INVENTION

The invention relates to resins comprising curable urea derivatives which are obtainable

(i) by reaction of one or more curable compounds, carrying one (preferably) or more groups selected from primary and secondary amino groups and mercapto, with one or more di- (preferably) or poly-isocyanates, optionally after or simultaneously with the formation of prepolymers in the presence of one or more in each case di- or higher functional alcohols, amines or aminoalcohols; or,

conversely, by reaction of one or more free-radically, anionically or cationically curable compounds, carrying one (preferably) or more isocyanato groups, with one or more organic compounds carrying two (preferably) or more groups selected from primary and secondary amino groups and mercapto;

wherein further reactants or additives may be used in each case,

to new synthetic mortars obtainable therewith;

to kits for producing such synthetic mortars;

to the use of the resins or synthetic mortars in fastening technology; and

to new fastening methods which comprise the use of those resins or synthetic mortars.

The general expressions and definitions used in the context of the present disclosure preferably have the meanings given hereinbelow, it being possible hereinabove and hereinbelow for the more specific meanings to be used instead of the more general expressions and definitions, resulting in preferred embodiments of the invention:

“Furthermore” means “in a broader, especially less preferred embodiment of the invention”. “Comprising” means “containing at least” so that further components may also be present or preferably signifies “containing”. “One or more” means preferably “from one to four”, especially “from one to three”, more especially “one or two”.

Where reference is made to the weight of the finished synthetic mortar or to the finished synthetic mortar, the total weight of all components of the synthetic mortar is preferably meant.

A resin is to be understood as preferably referring to those compositions which, as described hereinabove or preferably hereinbelow, have a content of curable urea derivatives and furthermore may include one or more further additives except for initiators. Among the additives, preference is given to reactive diluents, fillers, accelerators and inhibitors, which are added especially in the amounts mentioned hereinbelow as being preferred.

Primary and/or secondary amino-carrying, free-radically or, furthermore, anionically or cationically curable compounds are preferably defined as follows:

The primary and/or secondary amino group(s) is/are bonded to a radical containing one or more double bonds capable of polymerisation. Such radicals are especially the esters or, furthermore, thio esters or amides of vinyl group-carrying or substituted vinyl group-carrying acids which carry the primary or preferably secondary amino group(s) on the radical of the alcohol, thiol or amine component contributing to the ester, thio ester or amide.

The radicals of esters, thio esters or amides of vinyl group-carrying acids are especially those of formula (A),

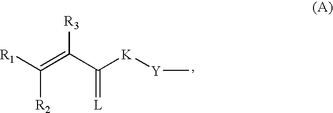

wherein

R₁, R₂ and R₃ denote, each independently of the others, hydrogen or lower alkyl, especially hydrogen or methyl; or

R₃ denotes cyano and R₁ and R₂ have the afore-mentioned meanings (leading to especially anionic polymerisation);

K and L denote, each independently of the other, oxygen or, furthermore, sulphur or denote NL* wherein L* is hydrogen or a radical selected from alkyl, especially lower alkyl, cycloalkyl, cycloalkylalkyl, aryl and aryl-lower alkyl, which are unsubstituted or substituted; and

Y denotes unsubstituted or substituted alkylene, or unsubstituted or substituted cycloalkylene, arylene, heteroarylene or heteroalkylene, or a mixed aliphatic/aromatic, aliphatic/alicyclic or aliphatic/heterocyclic, unsubstituted or substituted, bivalent radical;

or K and Y together or K alone denote(s) a bivalent heterocyclyl bonded by way of nitrogen.

Primary amino denotes —NH₂. A secondary amino group is a substituted amino group which in the uncharged state still carries one N-bonded hydrogen; as the N-substituent there come into consideration alkyl, cycloalkyl, cycloalkylalkyl, aryl, arylalkyl, heteroaryl or heteroarylalkyl, each of which may be substituted or preferably unsubstituted.

A secondary amino group can also be an imino group which is a constituent of an N-containing heterocyclyl radical.

An especially preferred secondary amino group is a group of formula (B),

—N(—R)H (B),

wherein R denotes alkyl, especially lower alkyl, primarily α-branched lower alkyl, especially isopropyl, isobutyl, sec-butyl or tert-butyl, cycloalkyl, such as cyclopropyl, cyclobutyl, cyclopentyl or cyclohexyl, cycloalkyl-alkyl, especially cyclohexylmethyl, aryl, especially phenyl, or aryl-lower alkyl, especially phenyl-lower alkyl, such as benzyl, especially lower alkyl.

Mercapto-carrying compounds are especially compounds such as the above-mentioned primary amino- and/or secondary amino-carrying compounds wherein, instead of one or more of the free or secondary amino groups, a mercapto group is in each case present.

It is also possible for such compounds to carry combinations of primary and secondary amino groups, of primary, or secondary, amino groups and mercapto groups or of all three of those types. Amongst such compounds preference is given to those carrying one primary or (preferably) secondary amino group and, where appropriate, one or more groups selected each independently of the other(s) from primary amino, secondary amino and mercapto. Special preference is, however, given to compounds carrying one or more groups of only one of those three types, especially those carrying one or more primary or secondary amino groups, more especially those carrying one (very especially) or more secondary amino groups.

Di- or poly-isocyanates are especially aliphatic (increasing the flexibility), cycloaliphatic or aromatic di- or poly-, especially di-, tri- or tetra-, isocyanates (serving for chain rigidity), especially hexane diisocyanate, dimethylene diisocyanate, 1,4-diisocyanato-butane, 1,5-diisocyanato-2-methylpentane, 1,8-diisocyanatooctane, 1,12-diisocyanato-dodecane, 4,4′-diisocyanatodicyclohexylmethane (H12-MDI), isophorone diisocyanate, 1-methylcyclohexane 2,4- or 2,6-diisocyanate, 3-isocyanatomethyl-3,5,5-trimethyl-cyclohexyl isocyanate or, more especially, aryl di- or aryl poly-isocyanates, especially toluene diisocyanate, for example toluene 2,4- or 2,6-diisocyanate, diisocyanato-diphenylmethane, especially 4,4′-methylene-bis(phenyl isocyanate) (MDI), 4,4′-isopropylidene diphenyl isocyanate, xylylene 1,3- or 1,4-diisocyanate; or crude polyisocyanates, which can be produced, for example, by aniline/formaldehyde condensation and subsequent phosgenation (cf. Ullmann, Verlag Chemie, 4th Edition, Volume 19, p. 303-305); or prepolymers having two or more isocyanato groups; or mixtures of two or more of the mentioned di- or poly-isocyanates. Special preference is given to diisocyanates or, furthermore, (for increased cross-linking as star-shaped molecules) triisocyanates.

The afore-mentioned prepolymers having two or more isocyanato groups are especially those that are formed by reaction starting from di- or poly-isocyanates, especially those mentioned in the last paragraph except for the prepolymers themselves, with in each case di- or higher functional alcohols (di- or poly-ols), di- or higher functional amines or di- or higher functional aminols, or mixtures of two or more thereof, di- or higher functional alcohols especially being hydroxyalcohols, for example reaction products of ethylene oxide or propylene oxide, such as ethanediol, di- or tri-ethylene glycol, propane-1,2- or 1,3-diol, dipropylene glycol, other diols, such as 1,2-, 1,3- or 1,4-butanediol, 1,6-hexanediol, neopentyl glycol, 2-ethylpropane-1,3-diol or 2,2-bis(4-hydroxycyclohexyl)propane, triethanolamine, bisphenol A or bisphenol F or oxyethylation, hydrogenation and/or halogenation products thereof, higher-hydric alcohols, such as, for example, glycerol, trimethylolpropane, hexanetriol and pentaerythritol, hydroxyl group-containing polyethers, for example oligomers of aliphatic or aromatic oxiranes and/or of higher cyclic ethers, for example ethylene oxide, propylene oxide, styrene oxide and furan, polyethers having in each case terminal hydroxy which contain aromatic structural units in the main chain, for example those of bisphenol A or F, hydroxyl group-containing polyesters based on the above-mentioned alcohols or polyethers and dicarboxylic acids or their anhydrides, for example adipic acid, phthalic acid, isophthalic acid, terephthalic acid, tetra- or hexa-hydrophthalic acid, endomethylene tetrahydrophthalic acid, tetrachlorophthalic acid or hexachloro-endomethylene tetrahydrophthalic acid, maleic acid, fumaric acid, itaconic acid, sebacic acid or the like. Special preference is given to hydroxyl compounds containing aromatic structural units bringing about chain rigidity, hydroxy compounds containing unsaturated components for increasing the cross-linking density, such as fumaric acid, or branched or star-shaped hydroxy compounds, especially tri- or higher functional alcohols and/or polyethers or polyesters which contain structural units thereof. Special preference is given to lower alkanediols (resulting in bivalent radicals —O-lower alkylene-O—). Di- or higher functional aminoalcohols are compounds especially containing one or more hydroxy groups and one or more amino groups in one and the same molecule. Preferred examples are aliphatic aminols, especially hydroxy-lower alkylamines (resulting in radicals —NH-lower alkylene-O— or —O-lower alkylene-NH—), such as ethanolamine, diethanolamine or 3-aminopropanol, or aromatic aminols, such as 2-, 3- or 4-aminophenol. Di- or higher functional amines are organic amino compounds containing 2 or more amino groups, especially hydrazine, N,N′-dimethylhydrazine, aliphatic di- or poly-amines, especially lower alkanediamines (resulting in radicals —NH-lower alkyl-NH—), such as ethylenediamine, 1,3-diamino-propane, tetra- or hexa-methylenediamine or diethylenetriamine, or aromatic di- or poly-amines, such as phenylenediamine, 2,4- and 2,6-toluenediamine, benzidine, o-chlorobenzidine, 2,5-p-dichlorophenyldiamine, 3,3′-dichloro-4,4′-diamino-diphenyl-methane or 4,4′-diaminodiphenylmethane, polyether diamines (polyethylene oxides containing terminal amino groups), or polyphenyl/polymethylene-polyamines which are obtainable by condensation of anilines with formaldehyde. It is also possible for mixtures of two or more of the mentioned, in each case di- or higher functional alcohols (preferred), amines or aminoalcohols to be present. Special preference is given to diols or triols, furthermore aminoalcohols, diaminoalcohols, aminodiols, diamines or triamines, especially those specifically mentioned. The diols, aminols and diamines are especially preferred; to these there may furthermore be added (as star carriers) triols, diaminoalcohols, aminodiols or triamines. The attributive phrase “in each case di- or higher functional” herein relates to all the compounds mentioned thereafter up to and including that separated from the preceding one by “and”, “or” or “and/or”, that is to say the phrase does not relate only to the first element of the listing in question.

The formation (production) of the prepolymers may be carried out at the same time as the reaction forming the curable urea derivatives according to the invention or separately, before the said reaction.

When produced beforehand, it is to be ensured, by virtue of the molar ratios, that two or more isocyanato groups can still be present terminally, for example by using the hydroxyalcohols, aminols and/or aminoamines in a less-than-stoichiometric amount than the di- or poly-isocyanates. Even when the reaction is carried out simultaneously, the molar ratios of the reaction components are preferably so selected that not too many of the free-radically, anionically or cationically curable compounds carrying one or more secondary amino groups are present, because these would otherwise bring about early chain termination for the prepolymers.

In a free-radically, anionically or cationically curable compound carrying one or more, especially one, isocyanato group(s), that group is bonded to a radical containing one or more double bonds capable of polymerisation. Such radicals are especially the esters or, furthermore, thio esters or amides of vinyl group-carrying or substituted vinyl group-carrying acids, which carry the isocyanato group(s) on the radical of the alcohol, thiol or amine component contributing to the ester, thio ester or amide.

The isocyanates of esters, thio esters or amides of vinyl group-carrying acids are especially those of formula (A*),

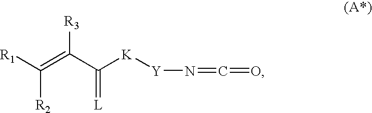

wherein

R₁, R₂ and R₃ denote, each independently of the others, hydrogen or lower alkyl, especially hydrogen or methyl;

or R₃ denotes cyano and R₁ and R₂ have the aforementioned meanings (leading to especially anionic polymerisation);

K and L denote, each independently of the other, oxygen or, furthermore, sulphur or denote NL* wherein L* is hydrogen or a radical selected from alkyl, especially lower alkyl, cycloalkyl, cycloalkylalkyl, aryl and aryl-lower alkyl, which are unsubstituted or substituted; and

Y denotes unsubstituted or substituted alkylene, or unsubstituted or substituted cycloalkylene, arylene, heteroarylene or heteroalkylene, or a mixed aliphatic/aromatic, aliphatic/alicyclic or aliphatic/heterocyclic, unsubstituted or substituted, bivalent radical;

or K and Y together or K alone denote(s) a bivalent heterocyclyl bonded by way of nitrogen. Examples for preparation and preferred compounds of that kind are to be found in EP 0 315 876, which is incorporated herein by way of reference especially in this regard. A preferred example is isocyanatoethyl methacrylate.

Organic compounds carrying two or more primary or secondary amino groups or, furthermore, mercapto groups are especially those organic compounds which carry two or, furthermore, more mercapto groups, preferably unsubstituted amino groups and/or especially substituted amino groups, which in the latter case have only one hydrogen atom on the nitrogen in the uncharged state, especially as defined hereinabove, preferably amino groups or especially secondary amino groups of formula (B), as defined hereinabove. The compounds carrying two or more of those groups are especially aliphatic (increasing the flexibility), cycloaliphatic or aromatic (serving for chain rigidity) di- or poly-, more especially di-, tri- or tetra-, -(GR)-carrying compounds, especially di-(GR)-hexane, -1,4-butane, -1,5-2-methylpentane, -1,8-octane, -1,12-dodecane, 4,4′-dicyclohexylmethane, -isophorone, -2,4- or -2,6-(1-methylcyclohexane), or more especially aryl-di- or aryl-poly-(GR), especially di-(GR)-toluene, -diphenylmethane, 2,4,4′-tri-(GR)-diphenylmethane, xylenediol-1,3- or -1,4-di-(GR), wherein (GR) in each case denotes amino, secondary amino or mercapto, especially primary or preferably secondary amino.

Halogen especially denotes fluorine, chlorine, bromine or iodine.

The prefix “lower” means that the radical in question has preferably up to 7, especially up to 4, carbon atoms.

Unsubstituted or substituted alkylene is preferably C₁-C₂₀alkylene, especially lower alkylene, which is unsubstituted or substituted by one or more, especially up to three, substituents selected each independently of the other(s) preferably from halogen, lower alkyl, such as methyl or ethyl, phenyl, phenyl-lower alkyl, lower alkoxy, phenyloxy, phenyl-lower alkoxy, lower alkoxy-carbonyl, phenyloxycarbonyl, phenyl-lower alkoxycarbonyl, nitro and cyano. Preference is given to ethylene or 1,3-propylene.

Unsubstituted or substituted cycloalkylene is preferably C₃-C₁₂-, especially C₄-C₈-, cycloalkylene, especially cyclopentylene, cyclohexylene or cycloheptylene, which is unsubstituted or substituted by one or more, especially up to three, substituents mentioned as substituents for substituted alkylene.

Arylene is especially the bivalent radical of a mono- to penta-cyclic aromatic radical containing from 6 to 30, preferably from 6 to 25, carbon atoms, which is unsubstituted or substituted, preferably as described for substituted alkylene, and is especially phenylene, lower alkyl-substituted phenylene, such as methylphenylene, the bivalent (preferably 4,4′-) radical of diphenylmethane, diphenyl-lower alkyl-methane, diphenyl-di-lower alkyl-methane, diphenyl-(mono- or poly-halo-lower alkyl)-methane or diphenyl-bis(mono- or poly-halo-lower alkyl)methane, especially the bivalent (preferably 4,4′-) radical of diphenylmethane, 1,1-diphenylethane, 2,2-diphenylpropane or 2,2-diphenyl-1,1,1,3,3,3-hexafluoropropane; the bivalent radical, bonded by way of the two phenyl substituents, of 1,1-dimethyl-3-methyl-(4-phenyl)-5-indan or the bivalent radical, bonded by way of the two phenyl substituents, of 9,9-di-(4-phenyl)-fluorene.

Heteroarylene is preferably the bivalent radical of a mono- to penta-cyclic radical containing at least one heterocycle and containing one or more ring hetero atoms, especially from 1 to 3 ring hetero atoms selected from N, S and O, which is unsubstituted or substituted, preferably as described for substituted alkylene, and is, for example, piperidinylene, piperazinylene, pyridin-2,6-ylene, 2-methylpyridin-2,4-ylene, phenazin-2,3-ylene, or the bivalent radical, bonded by way of the phenyl substituents, of 2,5-di(4-phenyl)-1,3,4-oxadiazole or -thiadiazole.

Heteroalkylene is branched or, especially, linear alkylene containing up to 100, preferably up to 20, chain atoms, of which one or more may be hetero atoms, especially N, S or O; the others are carbon atoms. Examples are polyoxy-ethylene or -propylene radicals or polythio-ethylene or -propylene radicals.

In an unsubstituted or substituted mixed aliphatic/aromatic, aliphatic/alicyclic or aliphatic/heterocyclic bivalent radical, the aliphatic moiety is preferably an alkylene radical as defined hereinabove, especially methylene, whereas the aromatic moiety is preferably arylene, the alicyclic moiety is preferably as defined for cycloalkylene and the heterocyclic moiety is preferably as defined for heteroarylene.

Alkyl is especially C₁-C₂₄-, especially C₁-C₁₂-, more especially lower, alkyl, which is branched one or more times or unbranched (linear) and which is unsubstituted or substituted by one or more, especially up to three, of the substituents mentioned as substituents for substituted alkylene. Preference is given to methyl, ethyl, n- or iso-propyl, or n-, iso- or tert-butyl.

Cycloalkyl is preferably C₃-C₁₂—, especially C₄-C₅—, cycloalkyl, especially cyclopropyl, cyclobutyl, cyclopentyl, cyclohexyl or cycloheptyl, which is unsubstituted or substituted by one or more, especially up to three, of the substituents mentioned as substituents for substituted alkylene.

Cycloalkylalkyl is preferably C₄-C₁₆—, especially C₄-C₈—, cycloalkylalkyl, especially cyclopropylmethyl, cyclobutylmethyl, cyclopentylmethyl, cyclohexylmethyl or cycloheptylmethyl, and is unsubstituted or substituted by one or more, especially up to three, of the substituents mentioned as substituents for substituted alkylene.

Aryl is a mono- to penta-cyclic aromatic radical containing from 6 to 30, preferably from 6 to 25, especially from 6 to 14, carbon atoms, which is unsubstituted or substituted, preferably as described for substituted alkylene, more especially phenyl or naphthyl.

Arylalkyl has preferably from 7 to 37, especially from 7 to 16, carbon atoms, aryl and alkyl being as defined hereinabove, and is unsubstituted or substituted by one or more, especially up to three, of the substituents mentioned as substituents for substituted alkylene.

Heteroaryl is a mono- to penta-cyclic radical containing at least one heterocycle and containing one or more ring hetero atoms, especially from 1 to 3 ring hetero atoms selected from N, S and O, which is unsubstituted or substituted, preferably as described for substituted alkylene, and is, for example, pyrrolyl, thiazolyl, oxazolyl or pyridyl.

In heteroarylalkyl, heteroaryl is unsubstituted or substituted, preferably as defined in the afore-mentioned manner, and bonded by way of an unbranched or branched alkylene radical, as defined for alkylene, preferably terminally, especially at methylene.

An N-containing heterocyclyl radical is especially a mono- to penta-, preferably mono-, bi- or tri-, cyclic heterocyclyl radical containing from 4 to 20, preferably from 5 to 14, ring atoms, and containing one or more, preferably up to three, ring hetero atoms, preferably selected from N, O and S, which is present in unsubstituted form or substituted by one or more, preferably up to three, substituents, especially selected each independently of the other(s) from halogen, lower alkyl, such as methyl or ethyl, phenyl, phenyl-lower alkyl, lower alkoxy, phenyloxy, phenyl-lower alkoxy, lower alkoxycarbonyl, phenyloxycarbonyl, phenyl-lower alkoxycarbonyl, nitro and cyano, preferably an unsaturated heterocyclyl radical, for example piperidino, piperazino, morpholino, thiomorpholino or the like. Bivalent heterocyclyl is preferably corresponding heterocyclylene. It is preferably heterocyclylene containing at least one or two ring nitrogen atoms, especially the radicals specifically mentioned hereinabove which in each case fall within that definition.

The content of curable urea derivatives in the resins according to the invention is preferably so proportioned that it is in a range of from 0.5 to 95% by weight, preferably from 5 to 70% by weight, based on the finished synthetic mortar.

The further reactants especially include reactive diluents (comonomers) with which, during curing, the new urea-derivative-based constituents can react instead of or in parallel to reacting with themselves. As reactive diluents there may be used any olefinically unsaturated compound suitable for the purpose, especially vinyl group-containing (including methacrylic or acrylic group-containing) compounds, for example styrene, divinylbenzene, mono-, di- and tri-acrylates or -methacrylates, such as methacrylic acid methyl ester, methacrylic acid isopropyl ester, methacrylic acid isobutyl ester, hexanediol diacrylate, tetraethylene glycol diacrylate, 2-hydroxypropyl methacrylate (2-HPMA), butanediol dimethacrylate (BDDMA), ethylene glycol dimethacrylate (EGDMA), trimethylolpropane trimethacrylate or tert-butyl aminoethyl methacrylate or vinyl acetate; or, furthermore, alkyl methacrylates (e.g. C₁₀-C₂₀alkyl, starting materials for “comb polymers”) or polyoxyethylene methacrylates, polyoxyethylene acrylates, polyoxyethylene 4-styryl-alkyl (especially methyl)esters, polyoxyethylene vinyl ethers or polybxyethylene fumarates, p-n-alkyl-styrene, n-alkylvinyl ether, N-(n-alkyl)maleimide, N-vinylpyrrolidone, N-vinylcarbazole, α-methylstyrene, indene or furan; or the like, or mixtures thereof. These are present preferably in an amount of from 1 to 80 percent by weight (% by weight), especially from 5 to 60% by weight, based on the finished synthetic mortar.

The resins comprising the new urea-derivative-based constituents may be pre-accelerated using, for example, pre-accelerators customary for cold-curing unsaturated polyesters (UP), especially using tertiary aromatic amines or heavy metal salts. Of the tertiary aromatic amines the following, especially, are possible: N,N-di-lower alkyl- or N,N-di-(hydroxy-lower alkyl (e.g. hydroxyethyl))-anilines, -toluidines or -xylidines, especially N,N-dimethyl- or N,N-diethyl-aniline, N,N-dimethyl- or N,N-diethyl-toluidines or -xylidines, such as N,N-dimethyl-p-toluidine, N,N-diisopropylindene-p-toluidine or N,N-bis(hydroxyethyl)-xylidine or -toluidine; as heavy metals salts, the following are, for example, possible: carboxylic acid salts of transition metals, such as cobalt octanoate or cobalt naphthenate, or organic vanadium salts. Those accelerators are present in a concentration of preferably up to 5% by weight, especially from 0.01 to 2% by weight, based on the finished synthetic mortar.

For the purpose of inhibition, inhibitors, especially free or sterically hindered quinones, hydroquinones or mono-, di- or tri-methylhydroquinones, or phenols, such as 4,4′-bis(2,6-di-tert-butylphenol), 1,3,5-trimethyl-2,4,6-tris(3,5-di-tert-butyl-4-hydroxybenzyl)-benzene or p-methoxyphenol, phenothiazines or the like may be added to the pre-accelerated resins or curable compounds. The inhibitors are present in an amount of preferably up to 2% by weight, especially between 0.01 and 1% by weight, based on the weight of the finished synthetic mortar.

As further additives, there are used, especially, fillers, especially mineral or mineral-like fillers, such as quartz, glass, porcelain, corundum, ceramics, talc, silicic acid (e.g. pyrogenic silicic acid), silicates, clay, titanium dioxide, chalk, basalt, barite, feldspar, aluminium hydroxide, granite or sandstone, polymeric fillers, such as thermosetting plastics, hydraulically curable fillers, such as gypsum, burnt lime or cement (e.g. Portland or aluminous cement), metals, such as aluminium, soot, or, furthermore, wood, mineral or organic fibres, or the like, or mixtures of two or more thereof. The fillers may be present in any form, for example as powder or ground material, or as shaped articles, e.g. in cylindrical, ring-shaped, spherical, flake, rod, saddle or crystal form, or, furthermore, in fibre form, and the basic particles in question have a maximum diameter of preferably from 0.001 to 10 mm. Fillers are preferably present in an amount of from 3 to 85% by weight in total, preferably from 5 to 70% by weight, based on the weight of the finished synthetic mortar.

Further possible additives are, furthermore, thixotropic agents, e.g. pyrogenic silicic acid, dyes or pigments, plasticisers, such as phthalic acid esters or sebacic acid esters, stabilisers, antistatic agents, thickeners or the like, which are preferably present in an amount of up to 15% by weight in total, preferably between 0.01 and 5% by weight, based on the finished synthetic mortar. Solvents may also be present, preferably in an amount of up to 30% by weight, based on the finished synthetic mortar, for example from 1 to 20% by weight, for example lower alkyl ketones, e.g. acetone, di-lower alkyl-lower alkanoyl amides, such as dimethylacetamide, lower alkyl benzenes, such as xylenes or toluene, phthalic acid esters or paraffins, or water.

For curing there are used anionic, cationic or free-radical initiators.

As initiators for curing of the resins there are used, in the case of free radical polymerisation, free-radical-forming compounds, primarily organic peroxides, such as diacyl peroxides, e.g. diacetyl peroxide, benzoyl or bis(4-chlorobenzoyl) peroxide, ketone peroxides, such as methyl ethyl ketone peroxide or cyclohexanone peroxide, or alkyl peresters, such as tert-butyl perbenzoate, or, furthermore, there come into consideration azo initiators, such as azonitriles, e.g. azobisisobutyronitrile or 2,2′-azobis(2,4-dimethylvaleronitrile), azo esters, such as dimethyl-2,2′-azobisisobutyrate, azo amides, such as 2,2′-azobis[2-methyl-N-(2-hydroxyethyl)propionamide], azo alkanes, such as 2,2′-azobis(2-methylpropane), azo amidines, such as 2,2′-azobis(2-methylpropionamidine)dihydrochloride, or azo imidazolines, such as 2,2′-azobis[2-(2-imidazolin-2-yl)propane]dihydrochloride, or persulphates or perborates, and also mixtures thereof. The initiators may be in pure form, for example tert-butyl perbenzoate, or, preferably, desensitised, e.g. using gypsum, chalk, pyrogenic silicic acid, phthalates, such as, especially, dicyclohexyl phthalate, chloroparaffin or the like, and, if desired, a filler may be added thereto, especially a filler as mentioned hereinabove, and/or (especially for producing a paste or emulsion) a solvent, especially water; the initiator is present in an amount of especially from 1 to 80% by weight, preferably from 20 to 60% by weight, and the desensitising agent in an amount of from 1 to 80% by weight, preferably from 30 to 70% by weight, in each case based on the total amount of hardener; fillers are present in an amount of from 0 to 50%, preferably from 0 to 20%, for example from 5 to 20%; and/or solvents are present in an amount of from 0 to 60%, preferably from 20 to 50%; and the hardeners are used as a powder (preferably), paste or emulsion.

As initiators for anionic polymerisation (which can be used in the case of, for example, α-cyanoacrylates) there are used, for example, metal alkyls, alcoholates, metal amides or metal hydroxides, e.g. sodium amide, or OH ions from atmospheric moisture or moisture in the masonry. As initiators for cationic polymerisation, for example in the case of vinyl ethers, Lewis acids are suitable, such as boron fluoride, aluminium chloride, titanium(IV) chloride or tin(IV) chloride. Free radical polymerisation is preferred.

The term “hardener” hereinabove and hereinbelow includes pure initiators and desensitised hardeners (initiators in the narrower sense) with or without added filler and/or added solvent, in other words the complete hardener component.

The amount of the hardener is in the range from 0.1 to 30% by weight, preferably from 0.5 to 25% by weight, based on the finished synthetic mortar.

The hardener may be incorporated in the non-curable component (especially the isocyanate component) or also, in suitable manner, e.g. in micro-encapsulated form, in the curable component.

A synthetic mortar according to the invention is obtainable by means of the full curing of a resin having a content of curable urea derivatives, as described hereinabove or, preferably, hereinbelow, after addition of a hardener and, where appropriate, further additives, and is, for example, the product of full curing within a hole, e.g. a drilled hole.

The synthetic mortar is produced preferably by mixing the resin having a content of curable urea derivatives or precursors thereof, either in situ (for example in a hole, such as a drilled hole) or, beforehand, outside thereof, for example in a static mixer, with a hardener and, if desired, further additives, as described hereinabove and hereinbelow.

A kit for producing a synthetic mortar according to the present invention is to be understood as being a kit comprising a resin according to the invention which comprises curable urea derivatives; it is to be understood as being, especially, an arrangement that allows the components for producing a mortar obtainable as described hereinabove and hereinbelow, namely a resin according to the invention having a content of curable urea derivatives, the hardener (in the form of a powder, paste or emulsion) and, optionally, further reactants and additives, to be mixed, and if necessary introduced, at the desired site, for example directly in front of or in a hole, so that full curing may take place there. The arrangement may consist of separate containers—although provided, for example, as a set, e.g. in a single package or a single container—for the resin, initiator or, where present, further additives, for example separate bottles, ampoules, tubes or cartridges for the components to be used, or may consist of cartridges of two or more chambers (having chambers arranged coaxially one inside the other or arranged in parallel next to one another, for holding the component in question) or shell casings, having two or more chambers, of glass, foils or plastics material, or combinations of two or more such containers, or, furthermore, in combination with expressing devices, such as expelling guns, and/or static mixers or nozzles/delivery tubes for expressing. Preference is given to combinations of two containers, one of which contains the resin and, where present, further additives, especially fillers, diluents and accelerators, whilst the other contains the hardener and also, where present, further additives, which may also, however, be accommodated in part or in entirety in further containers. Especially in the case of shell casings, the material of the walls thereof, e.g. glass, may be a constituent of the resulting synthetic mortar, as a further filler, after the application or filling procedure.

A fastening is to be understood as being especially a fastening employing anchoring means made of metal (e.g. undercut anchors, threaded rods or bolt anchors) or of another material, such as plastics or wood, in solid receiving materials, such as masonry, panels, posts or the like (e.g. made of concrete, natural stone, masonry of solid blocks or hollow blocks or, furthermore, plastics or wood), especially in holes, such as drilled holes.

The resins according to the invention having a content of curable urea derivatives are used primarily by introducing them at sites where fastening means are to be anchored, for example in holes, such as drilled holes, there being added to the resin and mixed therewith, beforehand or at the same time, a hardener, preferably as described hereinabove, and, if desired, further additives, preferably as described hereinabove, especially in the mixing ratios mentioned hereinabove. In the case of shell casings, mixing is carried out preferably by inserting the anchoring means; where separate containers or especially expelling guns employing cartridges are used, the components are mixed in a static mixer, especially shortly before introduction of the anchoring means.

The synthetic mortar is used especially by introducing it at the desired sites where anchoring means are to be fastened, especially holes, such as drilled holes, in non-cured or not yet fully cured form, and its final full curing is carried out in situ.

New fastening methods comprising the use of these resins or synthetic mortars are characterised especially by the method steps mentioned in the two preceding paragraphs. The fastening means, e.g. anchors, may be introduced, for example, by driving in, rotating, pushing in or combinations thereof.

### PREFERRED EMBODIMENTS OF THE INVENTION

In the case of the preferred embodiments of the invention hereinbelow there may be used, instead of general terms, the more specific definitions given hereinabove or hereinbelow, thereby defining especially preferred embodiments of the invention.

The invention relates preferably to a resin wherein, as the free-radically, anionically or cationically curable compound mentioned for preparation variant (i), carrying one or more groups selected from primary amino groups, secondary amino groups and mercapto, especially one or more secondary amino groups, there is used an ester, thio ester or amide of a vinyl group-carrying or substituted vinyl group-carrying acid, which carries the mentioned group(s) on the radical of the alcohol, thiol or amine component contributing to the ester, thio ester or amide, and, as di- or poly-isocyanate, there is used an aliphatic, cycloaliphatic or aromatic di- or poly-isocyanate, or a prepolymer having two or more isocyanato groups; or, as the free-radically, anionically or cationically curable compound mentioned for variant (ii), carrying one or more isocyanato groups, there is used an ester, thio ester or amide of a vinyl group-carrying or substituted vinyl group-carrying acid, which carries the isocyanato group(s) on the radical of the alcohol, thiol or amine component contributing to the ester, thio ester or amide and, as the compound carrying two or more primary amino groups, secondary amino groups and/or, furthermore, mercapto groups, there is used an aliphatic, cycloaliphatic or aromatic, di- or poly-(primary amino, secondary amino (preferably) and/or mercapto)-carrying compound;

wherein there are preferably present, both under (i) and under (ii), secondary amino group(s) which, each independently of the other(s), correspond to formula (B),

—N(—R)H (B),

wherein R denotes alkyl, especially lower alkyl, primarily α-branched lower alkyl, especially isopropyl, isobutyl, sec-butyl, tert-butyl, or, furthermore, cycloalkyl, such as cyclopropyl, cyclobutyl, cyclopentyl or cyclohexyl; cycloalkyl-alkyl, especially cyclohexylmethyl; or aryl, especially phenyl; or aryl-lower alkyl, especially phenyl-lower alkyl, such as benzyl; especially lower alkyl.

Greater preference is given to a resin especially according to the preceding paragraph which comprises a curable urea derivative obtainable according to variant (i), characterised in that, as (free-radically, anionically or cationically) curable compound carrying a primary or, especially, secondary amino group, there is used a compound of that kind of formula (I),

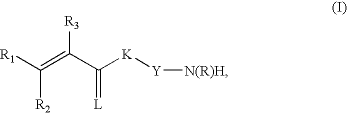

wherein R₁, R₂ and R₃ denote, each independently of the others, hydrogen or lower alkyl, especially hydrogen or methyl; or, furthermore,

R₃ denotes cyano and R₁ and R₂ have the afore-mentioned meanings;

K and L denote, each independently of the other, oxygen or, furthermore, sulphur or denote NL* wherein L* is hydrogen or a radical selected from alkyl, especially lower alkyl and, furthermore, cycloalkyl, cycloalkylalkyl, aryl and aryl-lower alkyl, which are unsubstituted or substituted;

Y denotes unsubstituted or substituted alkylene, especially lower alkylene, or, furthermore, unsubstituted or substituted cycloalkylene, arylene, heteroarylene or heteroalkylene, or a mixed aliphatic/aromatic, aliphatic/alicyclic or aliphatic/hetero-cyclic, unsubstituted or substituted, bivalent radical;

or, furthermore, K and Y together or Y alone denote(s) a heterocyclyl bonded by way of nitrogen; and

R denotes hydrogen or, preferably, alkyl, especially lower alkyl, primarily α-branched lower alkyl, especially isopropyl, isobutyl, sec-butyl, tert-butyl, or, furthermore, cycloalkyl, such as cyclopropyl, cyclobutyl, cyclopentyl or cyclohexyl; cycloalkyl-alkyl, especially cyclohexylmethyl; aryl, especially phenyl; or aryl-lower alkyl, especially phenyl-lower alkyl, such as benzyl; especially lower alkyl; and as di- or poly-isocyanate there is used an aliphatic, cycloaliphatic or aromatic di- or poly-, especially di-, tri- or tetra-, isocyanate, a crude polyisocyanate, which can be produced by aniline/formaldehyde condensation and subsequent phosgenation; or prepolymers having two or more isocyanato groups, obtainable starting from one or more aliphatic, cycloaliphatic or aromatic, di- or poly-, especially di-, tri- or tetra-, isocyanates by reaction with in each case di- or higher functional alcohols, amines or aminoalcohols.

Special preference is given to a resin, especially according to the second last paragraph, characterised in that it comprises compounds of formula (II),

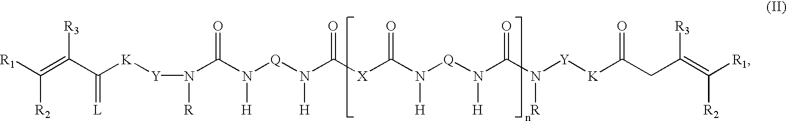

wherein R₁, R₂ and R₃ denote, each independently of the others, hydrogen or lower alkyl, especially hydrogen or methyl; or R₃ denotes cyano and R₁ and R₂ have the afore-mentioned meanings;

K and L denote, each independently of the other, oxygen or, furthermore, sulphur or denote NL* wherein L* is hydrogen or a radical selected from alkyl, especially lower alkyl and, furthermore, cycloalkyl, cycloalkylalkyl, aryl and aryl-lower alkyl, which are unsubstituted or substituted; and

Y denotes unsubstituted or substituted alkylene, or unsubstituted or substituted cycloalkylene, arylene, heteroarylene or heteroalkylene, or a mixed aliphatic/aromatic, aliphatic/alicyclic or aliphatic/heterocyclic, unsubstituted or substituted, bivalent radical;

or either K and Y; Y and N(R); or K, Y and N(R) together denote a heterocyclyl bonded by way of a ring nitrogen atom to C(=L) in the case of K and Y or to the adjacent C(=O) in the case of Y and N(R) and containing at least one secondary ring nitrogen atom or, in the case of K, Y and N(R), a heterocyclyl bonded by way of two ring nitrogen atoms and containing at least two secondary ring nitrogen atoms; R denotes hydrogen or, preferably, alkyl, especially lower alkyl, primarily α-branched lower alkyl, especially isopropyl, isobutyl, sec-butyl, tert-butyl, or, furthermore, cycloalkyl, such as cyclopropyl, cyclobutyl, cyclopentyl or cyclohexyl; cycloalkyl-alkyl, especially cyclohexylmethyl; aryl, especially phenyl; or aryl-lower alkyl, especially phenyl-lower alkyl, such as benzyl; especially lower alkyl;

Q denotes alkylene, cycloalkylene or arylene (this radical may also be a branching point when appropriate triisocyanates are used as starting materials);

X denotes the bivalent radical of a difunctional alcohol, a difunctional amine or a difunctional aminoalcohol, which is bonded by way of the hydroxy groups and/or the amino groups; especially —NH-lower alkylene-NH—, —O-lower alkylene-O—, —NH-lower alkylene-O— or —O-lower alkylene-NH—; and

n denotes a whole number between 0 and 100, especially between 0 and 10.

Even greater preference is given to resins according to the preceding paragraph which comprise a compound of formula II wherein

R₁, R₂ and R₃ denote, each independently of the others, hydrogen or lower alkyl, especially hydrogen or methyl;

K and L denote oxygen;

Y denotes lower alkylene;

R denotes lower alkyl, primarily α-branched lower alkyl, especially isopropyl, isobutyl, sec-butyl or tert-butyl;

Q denotes a bivalent (preferably 4,4′-) radical of diphenylmethane, diphenyl-lower alkyl-methane or diphenyl-di-lower alkyl-methane;

X denotes —O-lower alkylene-O—; and

n denotes a whole number between 0 and 10.

Great preference is given to a resin according to one of the last 4 preceding paragraphs which is suitable for producing a synthetic mortar, characterised in that it comprises, in addition to the curable urea derivative, which is present in an amount of from 0.5 to 95% by weight, preferably from 5 to 70% by weight, further reactants, especially reactive diluents, in an amount of from 1 to 80% by weight, preferably from 5 to 60% by weight, especially vinyl group-containing (including methacrylic or acrylic group-containing) compounds; and further additives, especially one or more selected from pre-accelerators, which are present in an amount of up to 5% by weight, preferably between 0.01 and 2% by weight, inhibitors, which are present in an amount of up to 2% by weight, preferably from 0.01 to 1% by weight, fillers, which are present in an amount of from 3 to 85% by weight, preferably from 5 to 65% by weight; and, furthermore, if desired, further additives selected from thixotropic agents, dyes, pigments, plasticisers, stabilisers, thickeners and antistatic agents, or mixtures of two or more of those additives, which may be present in an amount of up to 15% by weight in total, the stated amounts being based on the finished synthetic mortar.

Special preference is given to a resin according to the preceding paragraph in which there are used, as reactive diluents, mono-, di- or tri-acrylates or -methacrylates; as further additives, pre-accelerators selected from N,N-di-lower alkyl- or N,N-di-(hydroxy-lower alkyl)-aniline, -toluidine and -xylidine; and fillers selected from mineral or mineral-like fillers, polymeric fillers, hydraulically curable fillers, metals, soot, thermosetting plastics and, furthermore, wood, mineral and organic fibres, or the like, or mixtures of two or more thereof, in each case especially as defined hereinabove, and/or inhibitors, preferably in the amounts mentioned hereinabove as being preferred.

Very special preference is given to a synthetic mortar obtainable by adding a hardener and, if desired, further additives and/or reactants to a resin according to one of the preceding paragraphs containing preferred embodiments of the invention or especially by curing such a resin.

Greater preference is given to a synthetic mortar according to the preceding paragraph obtainable by adding a hardener which may comprise one or more initiators and, optionally, further additives (preferably excluding reactive diluents).

Very great preference is given to a synthetic mortar according to the preceding paragraph wherein the hardener comprises one or, furthermore, more initiators in an amount of, in total, from 1 to 80% by weight, preferably from 20 to 60% by weight; one or, furthermore, more desensitising agents in an amount of, in total, from 1 to 80% by weight, preferably from 30 to 70% by weight, one or more fillers in an amount of, in total, from 0 to 50% by weight, preferably from 0 to 20% by weight, especially from 5 to 20% by weight; and one or more solvents in an amount of, in total, from 0 to 60% by weight, for example especially from 20 to 50% by weight, the stated amounts being based on the hardener as such.

Special preference is given to a synthetic mortar according to one of the last two preceding paragraphs, wherein the hardener is used in an amount of from 0.1 to 30% by weight, preferably from 0.5 to 25% by weight, based on the weight of the finished synthetic mortar.

Preference is also given to the use, for producing a synthetic mortar, of a resin, according to one of the paragraphs hereinabove illustrating preferred resins, characterised in that the resin is mixed with a hardener and, if desired, further additives.

Preference is also given to a kit which comprises a resin according to one of the paragraphs hereinabove illustrating preferred resins, especially a kit allowing the resin, a hardener and, optionally, further reactants and additives to be mixed at the desired site, especially directly in front of or in a hole, so that full curing can take place there.

Preference is also given to a method of fastening anchors in holes which comprises the use of a resin according to one of the paragraphs hereinabove illustrating preferred resins or of a synthetic mortar according to one of the paragraphs hereinabove illustrating preferred synthetic mortars.

The invention relates especially to the urea derivative-comprising resins mentioned in the Examples, to the synthetic mortars described therein and their production and use, and also to kits comprising them.

The starting materials for the resins and synthetic mortars according to the invention, or precursors thereof, are, if their preparation is not known, commercially available and/or can be prepared by methods known per se.

### EXAMPLES

The Examples that follow serve to illustrate the invention, without implying any limitation.

### Example 1

### M12 Shell Casing (e.g. for Fastening an M12 Threaded Rod)

a) The hardener component and the resin component as the basis for a synthetic mortar are introduced separately into the chambers (outer glass container (larger ampoule) and inner glass container (smaller ampoule contained in the larger ampoule)) of an M12 shell casing. The following components are used:

Outer Glass Container:

| | |
|---|---|
| Urea urethane resin based on diisocyanatodiphenylmethane | 4.1 g |
| (MDI) and tert-butylaminoethyl methacrylate 60% in BDDMA, | |
| preaccelerated with amine | |
| Quartz sand (particle size 1.2-1.8 mm) | 9.6 g |

Inner Glass Container:

| | |
|---|---|
| Dibenzoyl peroxide 50% in dicyclohexyl phthalate | 0.3 g |

b) As an example of use, the shell casing described under a) is used as follows: The drilled hole is thoroughly cleaned, the shell casing is inserted therein and the threaded rod is installed by being rotated and driven in.

### Example 2

### Injection Mortar for 2-Chamber Cartridge

a) The following two components are filled separately into the two chambers of a two-chamber cartridge (as in the case of, for example, the injection mortar system FIS V 360 S of the company fischerwerke Artur Fischer GmbH & Co. K G, Waldachtal, Germany):

A-Component (Resin):

| | Proportion (% by |
|---|---|
| Constituent | weight) |
| Urea urethane resin based on MDI, aminoethanol | 35.00 |
| and methacrylic acid | |
| EGDMA | 10.5 |
| BDDMA | 9.8 |
| Dimethylaniline | 0.03 |
| Pyrogenic silicic acid | 1.12 |
| Quartz sand (particle size 0.08 to 0.2 mm) | 20.3 |
| Quartz sand (particle size 0.15 to 0.3 mm) | 9.67 |
| Cement | 13.58 |
| Σ | 100% |

B-Component (Hardener):

| | Proportion (% by |
|---|---|
| Constituent | weight) |
| Dibenzoyl peroxide | 14 |
| Water | 24 |
| Gypsum | 40 |
| Quartz sand | 20 |
| Pyrogenic silicic acid | 2 |
| Σ | 100 |

The volumetric ratio of A- to B-component is 5:1.

b) As an example of use, a perforated sleeve is placed in a hole in a hollow block and the synthetic mortar is filled in from the edge of the drilled hole using the cartridge produced under a). Immediately thereafter, a threaded rod is pushed in, with a slight rotary movement, as far as the bottom of the sleeve.

1. Resin comprising curable urea derivatives which are obtainable
(i) by reaction of one or more curable compounds, carrying one or more groups selected from primary and secondary amino groups and mercapto, with one or more di- or poly-isocyanates; or
(ii) conversely, by reaction of one or more free-radically, anionically or cationically curable compounds, carrying one or more isocyanato groups, with one or more organic compounds carrying two or more groups selected from primary and secondary amino groups and mercapto.

2. Resin according to claim 1, wherein, as the free-radically, anionically or cationically curable compound mentioned for variant (i), carrying one or more groups selected from primary amino groups, secondary amino groups and mercapto, there is used an ester, thio ester or amide of a vinyl group-carrying or substituted vinyl group-carrying acid, which carries the mentioned group(s) on the radical of the alcohol, thiol or amine component contributing to the ester, thio ester or amide, and, as di- or poly-isocyanate, there is used an aliphatic, cycloaliphatic or aromatic di- or poly-isocyanate, or a prepolymer having two or more isocyanato groups; or, as the free-radically, anionically or cationically curable compound mentioned for variant (ii), carrying one or more isocyanato groups, there is used an ester, thio ester or amide of a vinyl group-containing or substituted vinyl group-carrying acid, which carries the isocyanato group(s) on the radical of the alcohol, thiol or amine component contributing to the ester, thio ester or amide and, as the compound carrying two or more primary amino groups, secondary amino groups and/or, furthermore, mercapto, there is used an aliphatic, cycloaliphatic or aromatic, di- or poly-(primary amino, secondary amino and/or mercapto)-carrying compound;
wherein there are preferably present, both under (i) and under (ii), secondary amino group(s) which, each independently of the other(s), correspond to formula (B),
—N(—R)H (B),
wherein R denotes alkyl, especially lower alkyl, primarily α-branched lower alkyl, especially isopropyl, isobutyl, sec-butyl, tert-butyl, or, furthermore, cycloalkyl, such as cyclopropyl, cyclobutyl, cyclopentyl or cyclohexyl; cycloalkyl-alkyl, especially cyclohexylmethyl; or aryl, especially phenyl; or aryl-lower alkyl, especially phenyl-lower alkyl, such as benzyl; especially lower alkyl.

3. Resin according to claim 1, which comprises a curable urea derivative obtainable according to variant (i), characterised in that, as curable compound carrying a primary or secondary amino group, there is used a compound of that kind of formula (I), 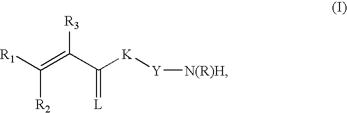
wherein
R₁, R₂ and R₃ denote, each independently of the others, hydrogen or lower alkyl, especially hydrogen or methyl; or, furthermore,
R₃ denotes cyano and R₁ and R₂ have the afore-mentioned meanings;
K and L denote, each independently of the other, oxygen or, furthermore, sulphur or denote NL* wherein L* is hydrogen or a radical selected from alkyl, especially lower alkyl and, furthermore, cycloalkyl, cycloalkylalkyl, aryl and aryl-lower alkyl, which are unsubstituted or substituted;
Y denotes unsubstituted or substituted alkylene, especially lower alkylene, or, furthermore, unsubstituted or substituted cycloalkylene, arylene, heteroarylene or heteroalkylene, or a mixed aliphatic/aromatic, aliphatic/alicyclic or aliphatic/hetero-cyclic, unsubstituted or substituted, bivalent radical;
or, furthermore, K and Y together or Y alone denote(s) a heterocyclyl bonded by way of nitrogen; and
R denotes hydrogen or, preferably, alkyl, especially lower alkyl, primarily α-branched lower alkyl, especially isopropyl, isobutyl, sec-butyl, tert-butyl, or, furthermore, cycloalkyl, such as cyclopropyl, cyclobutyl, cyclopentyl or cyclohexyl; cycloalkyl-alkyl, especially cyclohexylmethyl; aryl, especially phenyl; or aryl-lower alkyl, especially phenyl-lower alkyl, such as benzyl; especially lower alkyl; and as di- or poly-isocyanate there is used an aliphatic, cycloaliphatic or aromatic di- or poly-, especially di-, tri- or tetra-, isocyanate, a crude polyisocyanate, which can be produced by aniline/formaldehyde condensation and subsequent phosgenation; or prepolymers having two or more isocyanato groups, obtainable starting from one or more aliphatic, cycloaliphatic or aromatic, di- or poly-, especially di-, tri- or tetra-, isocyanates by reaction with in each case di- or higher functional alcohols, amines or aminoalcohols.

4. Resin according to claim 1, which comprises a compound of formula (II), 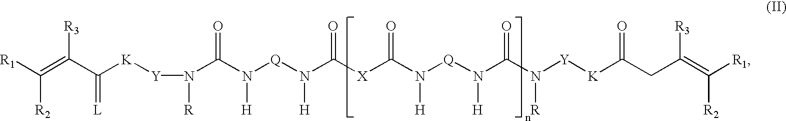
wherein
R₁, R₂ and R₃ denote, each independently of the others, hydrogen or lower alkyl, especially hydrogen or methyl; or
R₃ denotes cyano and R₁ and R₂ have the afore-mentioned meanings;
K and L denote, each independently of the other, oxygen or, furthermore, sulphur or denote NL* wherein L* is hydrogen or a radical selected from alkyl, especially lower alkyl and, furthermore, cycloalkyl, cycloalkylalkyl, aryl and aryl-lower alkyl, which are unsubstituted or substituted;
Y denotes unsubstituted or substituted alkylene, or unsubstituted or substituted cycloalkylene, arylene, heteroarylene or heteroalkylene, or a mixed aliphatic/aromatic, aliphatic/alicyclic or aliphatic/heterocyclic, unsubstituted or substituted, bivalent radical;
or either K and Y; Y and N(R); or K, Y and N(R) together denote a heterocyclyl bonded by way of a ring nitrogen atom to C(=L) in the case of K and Y or to the adjacent C(=O) in the case of Y and N(R) and containing at least one secondary ring nitrogen atom or, in the case of K, Y and N(R), a heterocyclyl bonded by way of two ring nitrogen atoms and containing at least two secondary ring nitrogen atoms;
R denotes hydrogen or, preferably, alkyl, especially lower alkyl, primarily α-branched lower alkyl, especially isopropyl, isobutyl, sec-butyl, tert-butyl, or, furthermore, cycloalkyl, such as cyclopropyl, cyclobutyl, cyclopentyl or cyclohexyl; cycloalkyl-alkyl, especially cyclohexylmethyl; aryl, especially phenyl; or aryl-lower alkyl, especially phenyl-lower alkyl, such as benzyl; especially lower alkyl;
Q denotes alkylene, cycloalkylene or arylene;
X denotes the bivalent radical of a difunctional alcohol, a difunctional amine or a difunctional aminoalcohol, which is bonded by way of the hydroxy groups and/or the amino groups; especially —NH-lower alkylene-NH-, —O-lower alkylene-O—, —NH— lower alkylene-O— or —O-lower alkylene-NH—; and
n denotes a whole number between 0 and 100, especially between 0 and 10.

5. Resin according to claim 4, which comprises a compound of formula II wherein
R₁, R₂ and R₃ denote, each independently of the others, hydrogen or lower alkyl, especially hydrogen or methyl;
K and L denote oxygen;
Y denotes lower alkylene;
R denotes lower alkyl, primarily α-branched lower alkyl, especially isopropyl, isobutyl, sec-butyl or tert-butyl;
Q denotes a bivalent (preferably 4,4′-) radical of diphenylmethane, diphenyl-lower alkyl-methane or diphenyl-di-lower alkyl-methane;
X denotes —O-lower alkylene-O—; and
n denotes a whole number between 0 and 10.

6. Resin according to one of claims 1 to 5, which is suitable for producing a synthetic mortar, characterised in that it comprises, in addition to the curable urea derivative, which is present in an amount of from 0.5 to 95% by weight, preferably from 5 to 70% by weight, further reactants, especially reactive diluents, in an amount of from 1 to 80% by weight, preferably from 5 to 60% by weight, especially vinyl group-containing (including methacrylic or acrylic group-containing) compounds; and further additives, especially one or more selected from pre-accelerators, which are present in an amount of up to 5% by weight, preferably between 0.01 and 2% by weight, inhibitors, which are present in an amount of up to 2% by weight, preferably from 0.01 to 1% by weight, fillers, which are present in an amount of from 3 to 85% by weight, preferably from 5 to 65% by weight; and also, if desired, further additives selected from thixotropic agents, dyes, pigments, plasticisers, stabilisers, thickeners and antistatic agents, or mixtures of two or more of those additives, which may be present in an amount of up to 15% by weight in total, the stated amounts being based on the finished synthetic mortar.

7. Resin according to claim 6, wherein there are used, as reactive diluents, mono-, di- or tri-acrylates or -methacrylates; as further additives, pre-accelerators selected from N,N-di-lower alkyl- or N,N-di-(hydroxy-lower alkyl)-aniline, -toluidine and -xylidine; and fillers selected from mineral or mineral-like fillers, polymeric fillers, hydraulically curable fillers, metals, soot, thermosetting plastics and, furthermore, wood, mineral and organic fibres, and the like, or mixtures of two or more thereof; and/or one or more inhibitors.

8. Synthetic mortar obtainable by adding a hardener and, if desired, further additives and/or reactants to a resin according to one of claims 1 to 7 or by curing such a resin.

9. Synthetic mortar according to claim 8, obtainable by adding a hardener which may comprise one or more initiators and, optionally, further additives.

10. Synthetic mortar according to claim 9, wherein the hardener comprises an initiator in an amount of from 1 to 80% by weight, preferably from 20 to 60% by weight; the desensitising agent in an amount of from 1 to 80% by weight, preferably from 30 to 70% by weight; fillers in an amount of from 0 to 50% by weight, preferably from 0 to 20% by weight, especially from 5 to 20% by weight; and solvent(s) in an amount of from 0 to 60% by weight, especially from 20 to 50% by weight, the stated amounts being based on the hardener as such.

11. Synthetic mortar according to one of claims 9 and 10, wherein the hardener is used in an amount of from 0.1 to 30% by weight, preferably from 0.5 to 25% by weight, based on the weight of the finished synthetic mortar.

12. Use, for producing a synthetic mortar, of a resin according to one of claims 1 to 7, characterised in that the resin is mixed with a hardener and, if desired, further additives.

13. Kit which comprises a resin according to one of claims 1 to 7.

14. Kit according to claim 13, which allows the resin, a hardener and, optionally, further reactants and additives to be mixed at the desired site, especially directly in front of or in a hole, so that full curing can take place there.

15. Method of fastening anchors in holes, which comprises the use of a resin according to one of claims 1 to 7 or of a synthetic mortar according to one of claims 8 to 11.
